(19) United States
(12) Patent Application Publication
(10) Pub. No.: US 2026/0009639 A1
(43) Pub. Date: Jan. 8, 2026

(54) DETECTION AND CORRECTION OF SENSOR MISALIGNMENT FOR MONITORING SYSTEMS AND APPLICATIONS

(71) Applicant: NVIDIA CORPORATION, Santa Clara, CA (US)

(72) Inventors: Yuzhuo REN, Sunnyvale, CA (US); Shagan SAH, Santa Clara, CA (US); Rajath Bellipady Shetty, Sunnyvale, CA (US); Pradipt TRIVEDI, Bangalore (IN); Sakthivel Sivaraman, San Jose, CA (US); Varsha Chandrashekhar HEDAU, Sunnyvale, CA (US); Dae Jin KIM, San Jose, CA (US)

(21) Appl. No.: 18/764,932

(22) Filed: Jul. 5, 2024

(51) Int. Cl. G01B 21/24; G06T 7/80; H04N 17/00

(52) U.S. Cl. CPC G01B 21/24; G06T 7/80; G06T 2207/20084; G06T 2207/30244; G06T 2207/30268; H04N 17/002

(57) ABSTRACT

Systems and methods are disclosed related to detection and correction of sensor misalignment for in-cabin monitoring systems and applications. For example, a misalignment between a current sensor state and a calibrated sensor state may be detected and quantified from corresponding test and reference frames of sensor data. When a threshold misalignment is detected, the test frame of sensor data may be used to generate and apply a corresponding calibration adjustment. The present techniques may be utilized to detect and correct sensor misalignment for use by autonomous machines, semi-autonomous machines, other types of ego-machines, and/or other sensing applications.

### BACKGROUND

Autonomous and semi-autonomous vehicles rely on machine learning approaches—such as those using deep neural networks (DNNs)—to analyze images of an interior space (e.g., cabin, cockpit) of a vehicle or other machine. An Occupant Monitoring System (OMS) is an example of a system that may be used within a vehicle cabin to perform real-time assessments of occupant or operator presence, gaze, alertness, and/or other conditions. For example, OMS sensors (such as, but not limited to, RGB sensors, infrared (IR) sensors, depth sensors, cameras, and/or other optical sensors) may be used to track an occupant's or operator's gaze direction, head pose, and/or blinking. This gaze information may be used to determine a level of attentiveness of the occupant or operator (e.g., to detect drowsiness, fatigue, and/or distraction), and/or to take responsive action to prevent harm to the occupant or operator (e.g., by redirecting their attention to a potential hazard, pulling the vehicle over, and/or the like). For example, DNNs may be used to detect that an operator is falling asleep at the wheel based on the operator's downward gaze toward the floor of the vehicle, and the detection may lead to an adjustment in the speed and direction of the car (e.g., pulling the vehicle over to the side of the road) or an auditory alert to the operator.

Occupant monitoring systems often rely on observations from multiple OMS sensors, which typically use their own coordinate systems. As a result, observations (e.g., of the body pose of an occupant) from different OMS sensors are often represented in different coordinate systems. In order to compare observations from different OMS sensors, the observations may be aligned by transforming them into a common frame of reference, such as a vehicle rig coordinate system. In order to transform the observations, the OMS sensors may be calibrated to the common frame of reference, and the calibration (e.g., extrinsic parameters representing sensor position and pose with respect to the common frame of reference) may be used to transform the observation to the common frame of reference. Proper extrinsic calibration ensures that sensor data generated using these sensors can be accurately fused and aligned in a common coordinate system.

However, an extrinsic sensor calibration may become invalidated or stale in a variety of scenarios. For example, vibration, shock, or mechanical stress experienced during vehicle operation can unintentionally move a mounted sensor (e.g., loosely mounted camera) relative to its originally calibrated position or orientation. Extreme environmental conditions like temperature variations, humidity, or exposure to moisture can impact sensor performance or stability, potentially compromising calibration accuracy. Other scenarios that can impact the validity of a sensor calibration include wear and tear from continuous use, software updates, or changes to processing algorithms. However, once a consumer vehicle has left the factory, sensors are not typically recalibrated outside of repairs, maintenance, or servicing, so conventionally, many of these issues go unresolved. During data collection programs, sensors may be manually recalibrated for each drive, but manual recalibration requires a great deal of time, effort, and computational demands, and may actually be unnecessary in many case. As such, there is a need for improved calibration techniques.

### SUMMARY

Embodiments of the present disclosure relate to detection and correction of sensor misalignment for in-cabin monitoring systems and applications. For example, systems and methods are disclosed that detect a sensor misalignment from frames of sensor data and generate a corresponding calibration adjustment.

For example, to detect and quantify misalignment, a (e.g., static) region mask or other representation of static and/or non-occluded regions (e.g., windows, in-vehicle infotainment display, interior roof, vehicle seats, dashboard, airbag compartment, etc. for in-vehicle applications; some other exterior reference point such as the ground plane, a portion of the body of an ego-machine such as a hood, etc. for exterior sensor applications) may be detected from a test frame and a reference frame of sensor data, any known difference or similarity quantification technique (e.g. SSIM) may be used to quantify the difference or similarity between the detected static regions. A lookup table or other mechanism may be used to map the measure of difference or similarity to a corresponding detected measure of misalignment (e.g., measure of sensor displacement and/or rotation relative to the calibrated sensor position), which may be compared to a desired calibration tolerance to determine whether a threshold misalignment exists. If so, calibration adjustment may be generated.

Depending on the embodiment, the calibration adjustment may be generated in various ways. For example, a lookup table may be used to map indexed (e.g., real and/or simulated) frames of sensor data (e.g., images) to corresponding calibration adjustments (e.g., transformation matrices), the test frame may be compared to the indexed frames to identify to most similar indexed frame, and a corresponding calibration adjustment may be looked up. Additionally or alternatively, a neural network (e.g., Siamese network) may be used to predict the calibration adjustment (e.g., components of a corresponding transformation matrix) based on the reference frame and the test frame, or based on the reference frame and a new frame generated using adjusted calibration parameters. As such, the detected sensor misalignment may be corrected by automatically applying a generated calibration adjustment or by guiding a user to manually adjust the sensor.

Accordingly, sensor misalignments may be automatically detected and corrected without the need for manual recalibration during repairs, maintenance, or servicing.

### BRIEF DESCRIPTION OF THE DRAWINGS

The present systems and methods for detection and correction of sensor misalignment for in-cabin monitoring systems and applications are described in detail below with reference to the attached drawing figures, wherein:

FIG. 1 is a data flow diagram illustrating an example sensor misalignment correction pipeline, in accordance with some embodiments of the present disclosure;

FIG. 2 is a diagram illustrating an example static region detector, in accordance with some embodiments of the present disclosure;

FIG. 3 illustrates an example neural calibration component, in accordance with some embodiments of the present disclosure;

FIG. 4 is a flow diagram illustrating a method of generating a calibration adjustment based at least on a test frame of sensor data, in accordance with some embodiments of the present disclosure;

FIG. 5 is a flow diagram illustrating a method of generating a calibration adjustment based at least on quantifying difference or similarity, in accordance with some embodiments of the present disclosure;

FIG. 6A is an illustration of an example autonomous vehicle, in accordance with some embodiments of the present disclosure;

FIG. 6B is an example of camera locations and fields of view for the example autonomous vehicle of FIG. 6A, in accordance with some embodiments of the present disclosure;

FIG. 6C is a block diagram of an example system architecture for the example autonomous vehicle of FIG. 6A, in accordance with some embodiments of the present disclosure;

FIG. 6D is a system diagram for communication between cloud-based server(s) and the example autonomous vehicle of FIG. 6A, in accordance with some embodiments of the present disclosure;

FIG. 7 is a block diagram of an example computing device suitable for use in implementing some embodiments of the present disclosure; and

FIG. 8 is a block diagram of an example data center suitable for use in implementing some embodiments of the present disclosure.

### DETAILED DESCRIPTION

Systems and methods are disclosed related to detection and correction of sensor misalignment for in-cabin monitoring systems and applications. For example, a misalignment between a current sensor state and a calibrated sensor state may be detected and quantified from corresponding test and reference frames of sensor data. When a threshold misalignment is detected, the test frame of sensor data may be used to generate and apply a corresponding calibration adjustment. The present techniques may be utilized to detect and correct sensor misalignment for use by autonomous machines, semi-autonomous machines, other types of ego-machines, and/or other sensing applications.

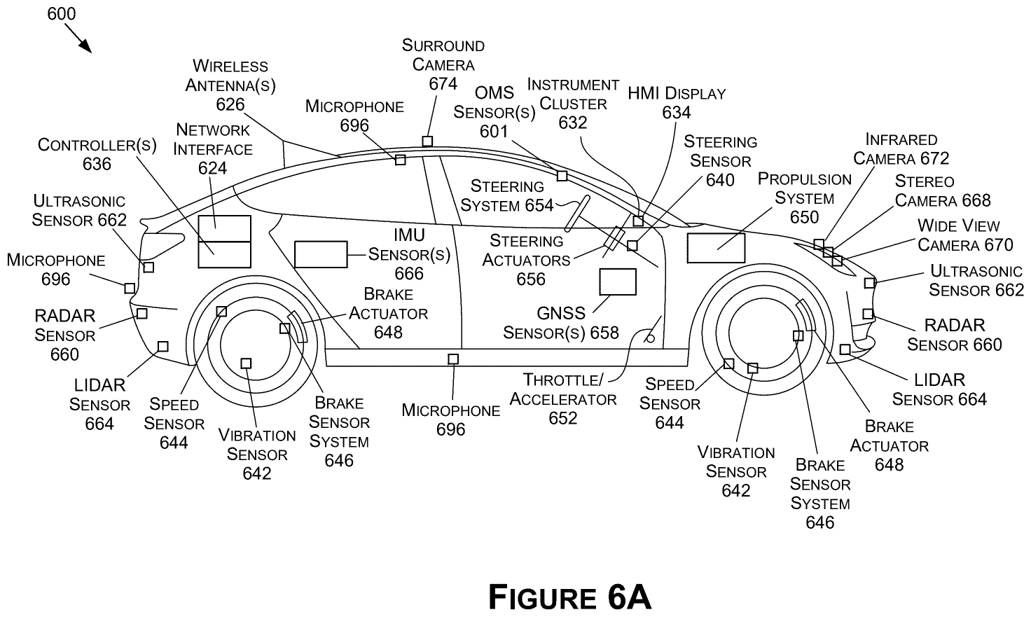

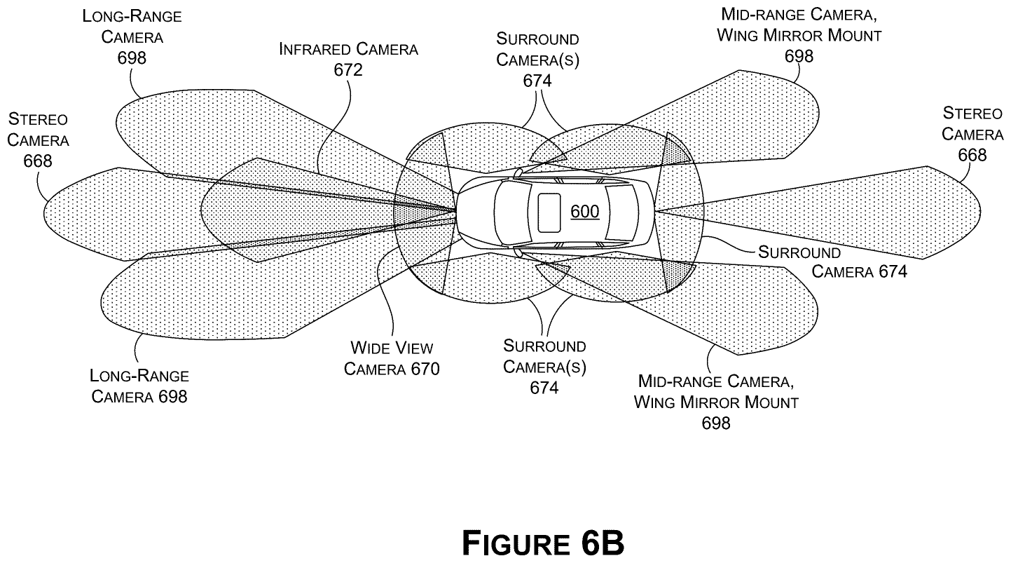

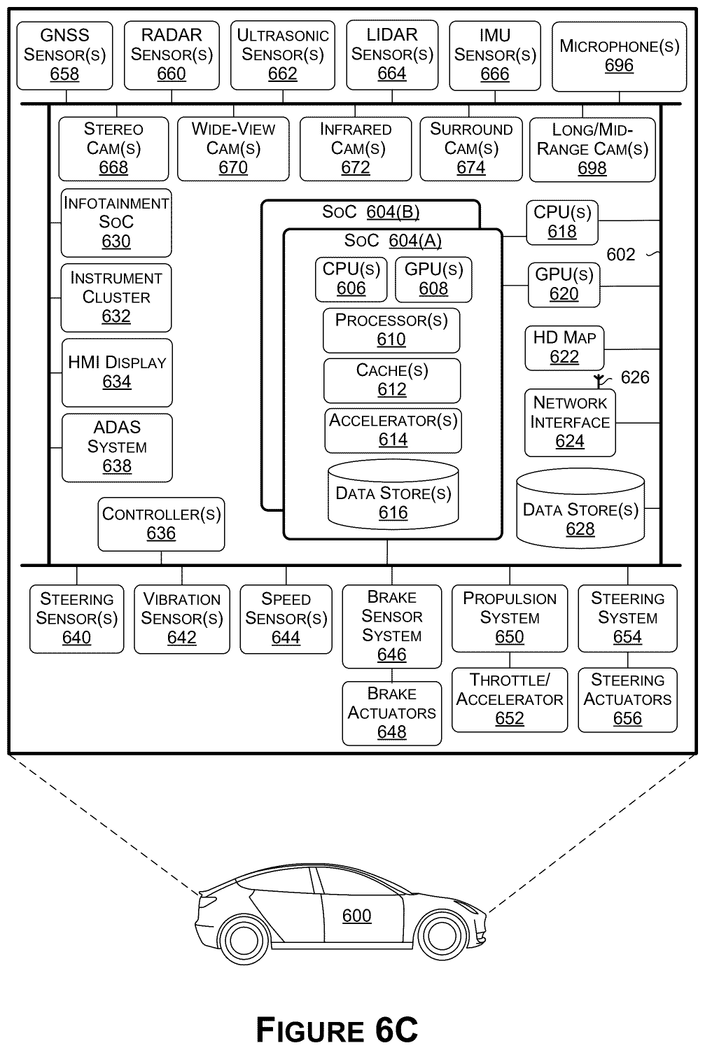

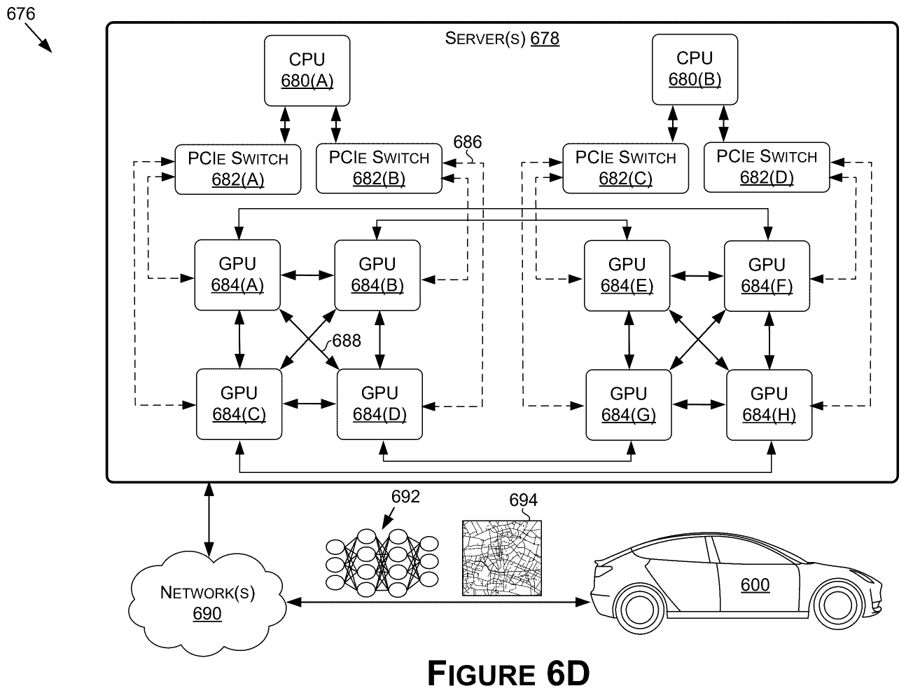

Although the present disclosure may be described with respect to an example autonomous or semi-autonomous vehicle or machine 600 (alternatively referred to herein as “vehicle 600” or “ego-machine 600,” an example of which is described with respect to FIGS. 6A-6D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to detecting and/or correcting misalignments of sensors in a cabin or cockpit of an ego-machine such as an autonomous vehicle, this is not intended to be limiting, and the systems and methods described herein may be used to detect and/or correct misalignments of sensors in—or views of—any real or virtual interior or exterior space.

In an example in-cabin or cockpit monitoring system such as a vehicle Occupant Monitoring System (OMS), one or more optical sensors may be positioned to observe a scene within the cabin, cockpit, or other interior space. An OMS may comprise a driver monitoring system (DMS), a system that monitors non-driver occupants, or a system that monitors driver occupant(s) and/or non-driver occupant(s). Optical sensors (e.g., RGB sensors, infrared IR sensors, depth sensors, cameras, etc.) may be positioned and/or dispersed in a variety of ways. For example, a DMS camera may be positioned within a steering column, vehicle pillar, or infotainment console, and oriented with its field of view facing toward the driver's seat. An OMS camera may be positioned overhead and oriented with a field of view facing down toward the front row of the vehicle and/or a back row of the vehicle. Generally, occupant and/or driver monitoring systems may include any number of cameras (e.g., 4 DMS cameras and 16 OMS cameras) positioned throughout a vehicle interior. These are just a few examples of possible sensor layouts, and other sensor layouts within any suitable real or virtual interior scene (e.g., a supermarket aisle, hospital operating room, retail store, office space, manufacturing facility, etc.) or exterior scene (e.g., a city street, construction site, agricultural field, public transportation hub, urban environment, etc.) may be implemented within the scope of the present disclosure.

In some embodiments, a real or virtual sensor (e.g., an interior camera of an ego-machine) may be used to generate a reference frame (e.g., of image data) representing an observed scene in a reference time slice in which the sensor has been or is considered calibrated or otherwise in a reference state. Subsequently, the sensor may be used to generate a corresponding test frame (e.g., of image data) representing the observed scene in a subsequent time slice. As such, the reference and test frames may be compared to generate a measure of misalignment between the state (e.g., position and orientation) of the sensor in the first time slice and the subsequent time slice. For example, a measure of difference or similarity (e.g., Structural Similarity (SSIM) Index) between the reference and test frames may be generated and used as an index in a lookup table to map the measure of difference or similarity to a corresponding measure of misalignment (e.g., sensor displacement and/or angle or rotation relative to the calibrated sensor position).

More specifically, to detect and quantify misalignment, a static region mask or other representation of static and/or non-occluded regions in each frame (e.g., windows, in-vehicle infotainment display, interior roof, vehicle seats, dashboard, airbag compartment, etc. for in-vehicle applications; some other exterior reference point such as the ground plane, a portion of the body of the ego-machine such as a hood, etc. for exterior sensor applications) may be generated and applied to the corresponding frame to generate a masked frame representing detected static regions. Static regions may be defined in various ways. For example, one or more regions of interest (ROIs) may be defined, and any known detection technique may be applied to detect those ROIs in each frame and generate a corresponding static region mask identifying those ROIs. In some embodiments, generated masks may be compared to simulated masks (e.g., generated from the perspective of a corresponding virtual camera viewing a 3D model (e.g., computer aided design model) of the environment such as a cockpit or other interior space) to identify and remove certain regions from the static region mask (e.g., detected occlusions). Additionally or alternatively, any known motion detection technique (e.g., optical flow) and/or other technique that relies on temporal information (e.g., temporal consistency from frame to frame) may be used to identify and remove regions from the static region mask representing detected dynamic objects (e.g., detected occlusions). These are just a few examples, and other variations are contemplated within the scope of the present disclosure. In some embodiments, any known high pass filtering and/or edge detection technique may be applied to each masked frame to detect static lines (e.g., contours edges) that are unlikely to result from illumination changes, effectively filtering out shadows from each masked frame.

As such, the masked test and reference frames representing the detected static regions of the observed scene may be used to detect and quantify misalignment, and determine whether a threshold misalignment exists. For example, any known difference or similarity quantification technique (e.g. SSIM) may be used to quantify the difference or similarity between the detected static regions represented in the masked test and reference frames. In some embodiments, a lookup table may be used to map the measure of difference or similarity to a corresponding detected measure of misalignment (e.g., sensor displacement and/or angle of rotation relative to the calibrated sensor position). The lookup table may be constructed in advance through experimentation to identify the correspondence between the measure of difference or similarity and corresponding measure of misalignment. As such, the detected measure of misalignment (e.g., measure of sensor displacement and/or rotation relative to the calibrated sensor position) may be compared to a desired calibration tolerance to determine whether a threshold misalignment exists.

For example, some computer vision features that rely on the test frame (e.g., gaze detection, pose detection, hands on wheel detection, presence detection, etc.) may depend on, or may have been trained based on, some threshold tolerance in the sensor calibration (e.g., within fractions of a degree for high-precision applications such as eye-tracking, within a few degrees for more general-purpose applications like gaze-based interaction in consumer devices or human-computer interfaces). There may be different tolerances in different directions (e.g., six degrees of freedom (6 DOF)), so the tightest tolerance may be compared to the detected measure of misalignment. If the detected measure of misalignment exceeds the designated tolerance, a determination may be made to determine and apply a calibration adjustment (or send a notification that a recalibration is needed or recommended).

A calibration adjustment may be generated in various ways. For example, a lookup table may be used to map pre-determined (e.g., real and/or simulated) images to corresponding calibration adjustments (e.g., transformation matrices). Images stored in the lookup table may represent an expected range of motion of the sensor within 6 DOF (e.g., combinations of five images spanning an expected range of motion in each of the 6 DOF, resulting in 30 images). As such, any suitable measure of similarity (e.g., SSIM) between the test frame and each of the indexed images may be generated to identify the most similar indexed image, and the corresponding calibration adjustment may be looked up. In some embodiments, the calibration adjustment may be applied to the current calibration parameters to adjust the calibration for the sensor.

Additionally or alternatively, a neural network (e.g., Siamese network) may be used to predict the calibration adjustment (e.g., components of a corresponding transformation matrix) based on the reference frame and the test frame, or based on the reference frame and a new frame generated using adjusted calibration parameters. In some embodiments, the neural network may operate in a loop to iteratively refine the calibration parameters by predicting a calibration adjustment, adjusting the previous calibration parameters, generating a new frame using the adjusted calibration parameters, and applying the reference frame and the new frame to the neural network to predict another calibration adjustment. The loop may be run until some completion criterion is achieved (e.g., a threshold measure of similarity between frames, predicted calibration adjustment or transformation lower than some designated threshold, some designated number of iterations, etc.). In some embodiments, training data for the neural network may be generated without human labeling. For example, reference images may be generated using any sensor (e.g., interior sensing cameras), random affine transformation matrices may be generated and used as ground truth, and corresponding test images may be generated by applying generated transformations to corresponding reference images. Other than the ease of obtaining training data, some such embodiments do not rely on other complex operations such as optical flow for motion detection or multi-camera input, such as stereo input for misalignment correction, easing computational demands.

Depending on the embodiment, a detected sensor misalignment may be corrected by automatically applying a generated calibration adjustment or by guiding a user to manually adjust the sensor. For example, a generated calibration adjustment (e.g., a transformation matrix) may be visualized (e.g., as a corresponding visual instruction such as an arrow) on a display visible to a user (e.g., an infotainment screen, a smart device, etc.) to guide the user to adjust the sensor position and/or orientation. In some embodiments, the reference frame and/or test frame may be visualized on the display, and the visualization of the test frame may be updated as the user updates the position and/or orientation of the sensor to match the visualized test frame with the visualized reference frame. In some embodiments, misalignment detection may be periodically performed during the manual adjustment, a corresponding calibration adjustment may be computed (e.g., using a look-up table or neural network), and a corresponding visualization may be presented on the display to update the guidance during the manual adjustment. As such, errors due to sensor rotation or translation may be corrected.

As such, sensor misalignments may be automatically detected and corrected without the need for manual recalibration during repairs, maintenance, or servicing. Since sensors (e.g., in consumer vehicles) are not typically recalibrated, the present techniques may be used to detect and correct many misalignments that conventional techniques cannot resolve. Furthermore, by detecting and quantifying misalignment, and determining whether a threshold misalignment exists, unnecessary calibration adjustment may be avoided. As such, the present techniques offer an improvement over conventional manual calibration techniques, thereby reducing the time, effort, and computational demands needed to ensure sensor calibrations remain within a desired tolerance.

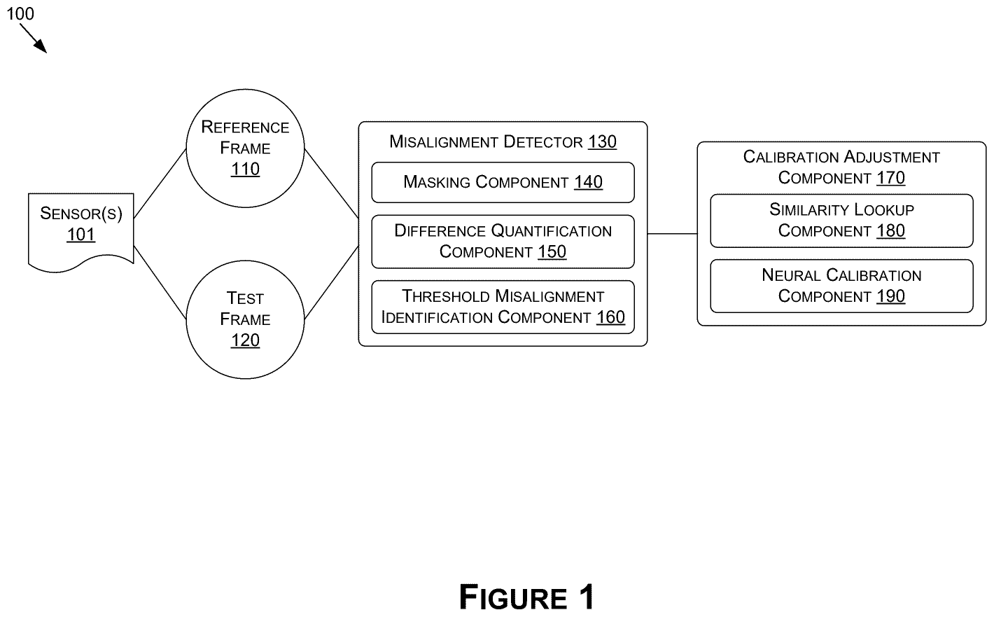

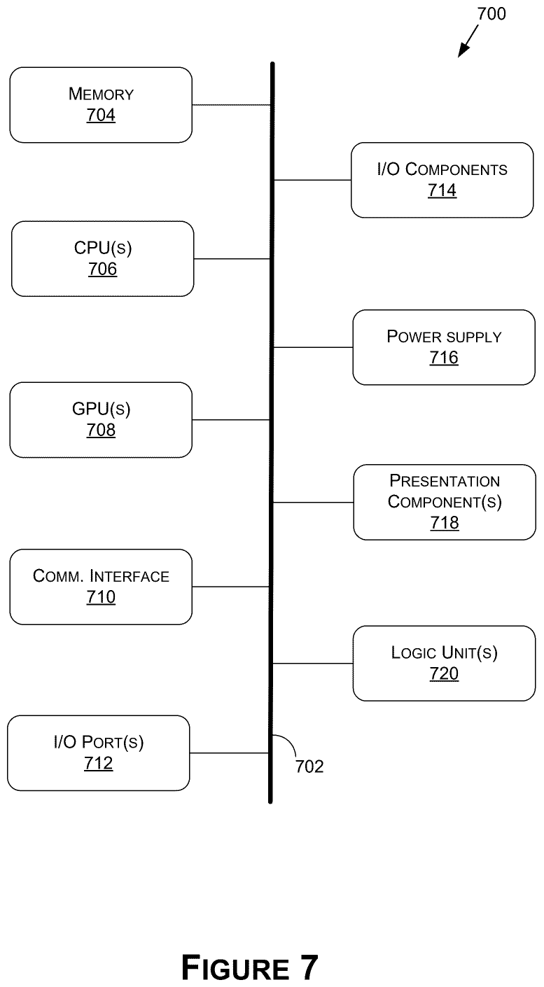

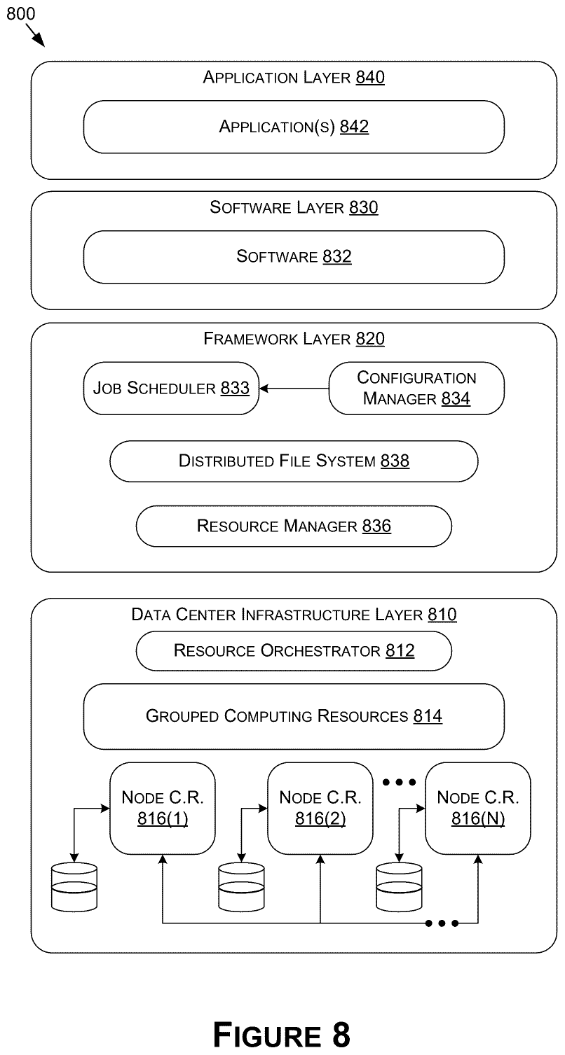

With reference to FIG. 1, FIG. 1 is an example sensor misalignment correction pipeline 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 600 of FIGS. 6A-6D, example computing device 700 of FIG. 7, and/or example data center 800 of FIG. 8.

In an example data flow through the sensor misalignment correction pipeline 100, each sensor of one or more sensor(s) 101 positioned and oriented in a reference state may be used to generate a reference frame 110 (e.g., of image data) representing an observed scene in a reference time slice, and the sensor(s) 101 may subsequently be used to generate a test frame 120 (e.g., of image data) representing the observed scene in a subsequent time slice. A misalignment detector 130 may detect whether there is a threshold misalignment between the reference and subsequent states of the sensor(s) 101 (e.g., whether the sensor(s) 101 have moved) using the reference frame 110 and the test frame 120 from each of the sensor(s) 101, and if so, the calibration adjustment component 170 may generate a calibration adjustment based on the test frame 120 (and optionally the reference frame 110), and may use the calibration adjustment to automatically adjust the calibration of the sensor(s) 101 and/or guide a manual adjustment. Generally, the sensor misalignment correction pipeline 100 may execute on demand (e.g., in response to a user command) and/or periodically (e.g., on start-up, at the beginning or end of a journey, periodically during a journey, at a designated maintenance interval, etc.).

Generally, the sensor(s) 101 may include any number and type of sensor (e.g., cameras, RADAR sensors, LIDAR sensors, ultrasonic sensors), such as one or more sensors of an ego-machine (e.g., a vehicle). In some embodiments, the sensor(s) 101 include one or more optical sensors (e.g., cameras) positioned within an interior space, such as a cabin or cockpit of an ego machine. For example, the sensor(s) 101 may be part of a DMS or OMS that monitors driver and/or non-driver occupants within a cabin, cockpit, or other interior space. For example, the sensor(s) 101 may include optical sensors (e.g., RGB sensors, infrared IR sensors, depth sensors, cameras, etc.) that may be positioned and/or dispersed in a variety of ways (e.g., positioned within a steering column, vehicle pillar, or infotainment console and oriented with its field of view facing toward the driver's seat). In some embodiments, the sensor(s) 101 may include an OMS camera positioned overhead in a vehicle and oriented with a field of view facing down toward the front row of the vehicle and/or a back row of the vehicle. Generally, occupant and/or driver monitoring systems may include any number of sensor(s) 101 (e.g., cameras) positioned throughout a vehicle interior. These are just a few examples of possible sensor(s) 101 and layouts, and other sensor(s) 101 and layouts may be used within any real or virtual interior scene (e.g., supermarket aisle, hospital operating room, retail store, office space, manufacturing facility, etc.) or exterior scene (e.g., city street, construction site, agricultural field, public transportation hub, urban environment, etc.).

Each of the sensor(s) 101 (e.g., each interior camera of an ego-machine) may be used to generate a reference frame 110 (e.g., of image data) and a test frame 120 (e.g., of image data). For example, the reference frame 110 may represent an observed scene (e.g., a portion of a cabin or cockpit) in a reference time slice during which the sensor(s) 101 are considered calibrated or otherwise in a reference state. However, the sensor(s) 101 may move for various reasons, such as vibrations (e.g., experienced during navigation); collisions; extreme environmental conditions such as temperature variations, humidity, or exposure to moisture; and wear and tear. Furthermore, the accuracy of the calibration of the sensor(s) 101 may be impacted by events such as software updates; changes to processing algorithms; and/or other factors. As a result, sensor data generated using the sensor(s) 101 at some later time slice may not align with the calibration for the sensor(s) 101, and a test frame 120 representing the observed scene in a subsequent time slice may not align with the reference frame 110. This situation may occur in a variety of scenarios. For example, the reference frame 110 may represent an observed scene prior to embarking on a route when the sensor(s) 101 have been subject to a pre-drive calibration, and the test frame 120 may represent the scene after the route. In another example, the reference frame 110 may represent a reference state when the sensor(s) 101 have been subject to a factory calibration, and the test frame 120 may represent some subsequent state (e.g., after the ego-machine has been delivered to a consumer). Generally, a misalignment between the reference sensor state and a subsequent sensor state can negatively impact the accuracy impact downstream (e.g., machine perception) tasks that operate on sensor data from the sensor(s) 101 and rely on a particular calibration tolerance.

As such, the misalignment detector 130 may compare the reference frame 110 and the test frame 120 to generate a measure of misalignment between the reference state (e.g., position and orientation) of the sensor(s) 101 in the reference time slice and the subsequent state in the subsequent time slice. In the embodiment illustrated in FIG. 1, the misalignment detector 130 includes a masking component 140, a difference quantification component 150, and a threshold misalignment identification component 160. The masking component 140 may generate a representation of static and/or non-occluded regions in the reference frame 110 and the test frame 120 (e.g., masked frames representing detected static content in the reference frame 110 and the test frame 120), the difference quantification component 150 may generate a measure of difference or similarity (e.g., SSIM) between the masked frames and convert the measure of difference or similarity to a corresponding measure of misalignment, and the threshold misalignment identification component 160 may compare the measure of misalignment to a designated calibration tolerance. If the measure of misalignment meets and/or exceeds the tolerance, the threshold misalignment identification component 160 may instruct the calibration adjustment component 170 to generate a calibration adjustment and/or calibration adjustment guidance.

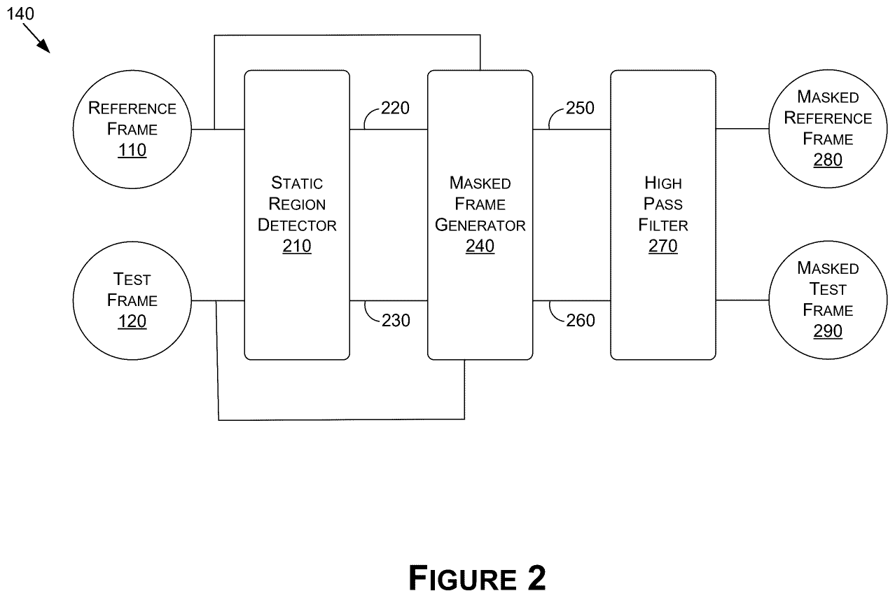

More specifically, the masking component 140 may evaluate the reference frame 110 and the test frame 120 (or just the test frame 120 in some embodiments in which the test frame 120 was previously evaluated) to detect static and/or non-occluded regions (e.g., in each frame, common to both frames), generate a corresponding representation(s) of the detected static regions (e.g., a static region mask), and use the representation(s) of the detected static regions to mask the other regions (e.g., depicting moving content) in the frames (e.g., generating masked frames for the reference frame 110 and the test frame 120). FIG. 2 is a diagram illustrating an example masking component 140, in accordance with some embodiments of the present disclosure. In the embodiment illustrated in FIG. 2, the masking component 140 includes a static region detector 210, a masked frame generator 240, and high pass filter 270.

Generally, the static region detector 210 may use any known technique to generate a static region mask or other representation of static and/or non-occluded regions in the reference frame 110 and the test frame 120 (e.g., windows, in-vehicle infotainment display, interior roof, vehicle seats, dashboard, airbag compartment, etc. for in-vehicle applications; some other exterior reference point such as the ground plane, a portion of the body of the ego-machine such as a hood, etc. for exterior sensor applications). Taking the test frame 120 as an example, one or more ROIs may be defined, and the static region detector 210 may apply any known detection technique to detect those ROIs in the test frame 120. By way of nonlimiting example, the static region detector 210 may detect a designated region using edge detection (e.g., analyzing detected edges to locate designated shapes, boundaries, or areas that correspond to the desired ROI), template matching (e.g., using a designated template to find a corresponding pattern in the test frame 120), perception (e.g., using machine learning models like convolutional neural networks (CNNs)), and/or otherwise. As such, the static region detector 210 may generate a reference frame mask 220 and/or a test frame mask 230 identifying detected static regions in the reference frame 110 and test frame 120, respectively.

In some embodiments, the static region detector 210 may remove regions representing occlusions (e.g., moving objects) and/or motion from the reference frame mask 220 and/or a test frame mask 230. Taking the test frame mask 230 as an example, the static region detector 210 may compare the test frame 120 (or data derived therefrom) to corresponding simulated data. For example, the target scene being observed may be simulated in a static state as a 3D model of the environment (e.g., an empty vehicle cabin). In some embodiments, a virtual camera may be positioned in the 3D environment model, a simulated frame (e.g., a 2D image) may be generated, and the simulated frame may be compared to the test frame 120 (e.g., converting to greyscale, applying thresholding, subtracting one image from the other to represent) to identify areas where pixel values differ more than a threshold amount (e.g., representing occlusions) and remove those regions from the test frame mask 230. Additionally or alternatively, the 3D environment model may be used to generate a simulated depth map, and the static region detector 210 may convert the test frame 120 into a depth map using any known technique (e.g., using a neural network), compute the difference between the depth values in corresponding pixels of the test depth map generated from the test frame 120 and the simulated depth map, use the resulting difference map to identify areas where the depth varies more than a threshold amount, and remove those regions from the test frame mask 230. In some embodiments, the static region detector 210 may segment the background (e.g., the static regions, such as the frame of the car, car seats, etc.) from the foreground (e.g., the dynamic regions, such as the occupants of the vehicle) in the test frame 120, and remove regions from the test frame mask 230 corresponding to the foreground. As such, the static region detector 210 may identify and remove regions from the test frame mask 230 that do not correspond to the expected static scene (e.g., detected occlusions).

Additionally or alternatively, the static region detector 210 may use any known motion detection technique (e.g., optical flow) and/or other technique that relies on temporal information (e.g., temporal consistency from frame to frame) to identify and remove regions representing detected dynamic objects (e.g., detected occlusions) from the test frame mask 230. For example, the static region detector 210 may use optical flow to track moving objects in a vehicle (e.g., people entering or exiting the vehicle) and may project their tracked locations into the test frame mask 230 to identify and remove regions associated with dynamic objects (e.g., occluded regions) from the test frame mask 230.

As such, the masked frame generator 240 may apply the test frame mask 230 to the test frame 120 to generate a masked test frame 260, and may apply the reference frame mask 220 to the reference frame 110 to generate a masked reference frame 250. As such, the masked test frame 260 and the masked reference frame 250 may depict or otherwise represent only those regions in which static content was detected.

In some embodiments, the high pass filter 270 applies any known high pass filtering and/or edge detection technique to the masked test frame 260 and/or the masked reference frame 250 to detect or emphasize static lines (e.g., contours edges) that are unlikely to result from illumination changes, and/or filter out lower frequency content likely to represent illumination changes such as shadows. For example, the high pass filter 270 may subtract a low-pass filtered version of an image from the original image and/or apply a filter that emphasizes the high-frequency components, effectively removing the slower changing elements, such as gradual shifts in lighting. In some embodiments, the high pass filter 270 may use edge detection techniques such as Sobel or Canny edge detection to generate a mask or other representation of detected edges that correspond to static content, and use the mask to enhance the static content (e.g., by increasing the contrast around the detected edges in the original image, adding the detected edges to the original image). Although the high pass filter 270 is illustrated as operating on the masked frames (e.g., the masked test frame 260), in some embodiments, the high pass filter 270 may be applied elsewhere (e.g., to the test frame 120 and/or the reference frame 110).

As such, the high pass filter 270 may effectively filter out dynamic content (e.g., shadows) that might otherwise introduce differences that do not result from calibration changes, and may be used to generate a masked reference frame 280 and/or a masked test frame 290 (or in some embodiments, the masked reference frame 250 and/or the masked test frame 260 may be used as the masked reference frame 280 and/or the masked test frame 290, respectively, without high pass filtering).

As such, and returning now to FIG. 1, the difference quantification component 150 may generate a measure of difference or similarity (e.g., SSIM number) between the masked reference frame 280 and the masked test frame 290, and may use the measure of difference or similarity to generate a corresponding measure of misalignment (e.g., sensor displacement and/or angle of rotation relative to the calibrated sensor state). For example, the difference quantification component 150 may use SSIM to evaluate the identified static regions of the masked reference frame 280 and the masked test frame 290 to quantify difference or similarity of the corresponding static regions. In some embodiments, to reduce possible impacts from sensor noise, the difference quantification component 150 may subdivide one or more common static regions between the masked reference frame 280 and the masked test frame 290 (e.g., regions above a threshold length, area, etc.) into smaller patches (e.g., patches of 32×32 or 64×64 pixels), apply SSIM within each patch, and aggregate the resulting scores (e.g., using averaging, majority voting, etc.) to derive an overall measure of similarity between the static regions of the masked reference frame 280 and the masked test frame 290. In some embodiments, the difference quantification component 150 may quantify similarity or difference using any known machine learning technique (e.g., using a neural network that extracts a value quantifying difference between two input images, quantifying the difference between feature vectors extracted from corresponding images using a neural network, etc.). These are just a few examples, and other techniques to quantify difference or similarity (e.g., mean squared error quantifying difference between corresponding pixels, histogram comparison, etc.) may be implemented within the scope of the present disclosure.

In some embodiments, the difference quantification component 150 may convert the measure of difference or similarity into a corresponding measure of detected misalignment (e.g., sensor displacement and/or angle of rotation relative to the calibrated sensor position), and the threshold misalignment identification component 160 may compare the detected measure of misalignment to a designated threshold to determine whether a threshold misalignment exists. For example, the correspondence between the measure of difference or similarity (e.g., SSIM values from −1 to +1) and the corresponding measure of misalignment (e.g., sensor displacement or angle of rotation in one of six degrees of freedom, the maximum sensor displacement or angle of rotation among six possible degrees of freedom) may be measured or approximated (e.g., during a design or test phase), and the correspondence may be represented in any suitable way, such as via a lookup table, regression analysis, or some other model. As such, the difference quantification component 150 may use the correspondence to convert a detected measure of difference or similarity into a corresponding measure of detected misalignment. Taking SSIM as an example, SSIM values span from −1 (indicating dissimilarity) to +1 (indicating similarity), so SSIM values farther from +1 may indicate that a corresponding one of the sensor(s) 101 (e.g., a camera) has moved a relatively larger amount.

Accordingly, the threshold misalignment identification component 160 may compare the detected measure of misalignment to a designated threshold (e.g., a designated calibration tolerance) to determine whether a threshold misalignment exists. For example, some downstream computer vision or other machine learning tasks (e.g., gaze detection, pose detection, hands on wheel detection, presence detection, etc.) may rely on the sensor(s) 101 that generated the test frame 120 having a calibration within some threshold tolerance (e.g., within fractions of a degree for high-precision applications such as eye-tracking, within a few degrees for more general-purpose applications like gaze-based interaction in consumer devices or human-computer interfaces). Accordingly, the threshold misalignment identification component 160 may compare the detected measure of misalignment to a designated threshold tolerance. Depending on the task and/or the embodiment, there may be different tolerances for different tasks and/or in different directions (e.g., 6 DOF), so the threshold misalignment identification component 160 may compare the tightest tolerance to the detected measure of misalignment. If a detected measure of misalignment is within the designated tolerance, the threshold misalignment identification component 160 may determine that calibration adjustment is not necessary. Otherwise, if the detected measure of misalignment meets and/or exceeds the designated tolerance, the threshold misalignment identification component 160 may instruct the calibration adjustment component 170 to generate a calibration adjustment.

The calibration adjustment component 170 may generate a calibration adjustment based on the test frame 120 (and optionally the reference frame 110), and may use the calibration adjustment to automatically adjust the calibration of the sensor(s) 101 and/or guide a manual adjustment. The calibration adjustment component 170 may generate the calibration adjustment in various ways. For example, the calibration adjustment component 170 may include a similarity lookup component 180 that compares the test frame 120 to indexed frames of sensor data (e.g., images) in a lookup table to map the test frame 120 to a corresponding calibration adjustment (e.g., sensor transformation). Additionally or alternatively, the calibration adjustment component 170 may include a neural calibration component 190 that uses a neural network (e.g., a Siamese network) to predict a calibration adjustment (e.g., sensor transformation) based on the reference frame 110 and the test frame 120, or based on the reference frame 110 and a new frame generated using adjusted calibration parameters.

The similarity lookup component 180 may rely on one or more lookup tables that map real and/or simulated frames of sensor data (e.g., real and/or simulated images) to corresponding calibration adjustments (e.g., transformation matrices). For example, a designated range of motion of the sensor(s) 101 may be segmented into a designated number of discrete points in one or more degrees of freedom (e.g., six), and a frame of sensor data may be generated or otherwise obtained for each point. By way of nonlimiting example, if the desired range of coverage of the lookup table is +/−1 centimeter of displacement and +/−5 degrees of rotation, the range of motion in each direction may be segmented into or otherwise represented by five points (or different ranges or directions may be represented by different numbers of points), and a frame of sensor data (e.g., image) may be generated for each point. In the example of five data points for each of six degrees of freedom, thirty frames of sensor data (e.g., image) may be generated using corresponding sensor orientations and stored in a lookup table that associates each frame with a corresponding sensor displacement and rotation.

As such, the similarity lookup component 180 may use any known technique to quantify similarity between the test frame 120 and each of the indexed frames (e.g., images) in the lookup table. For example, the similarity lookup component 180 may quantify similarity using one or more neural networks (e.g., CNNs), SSIM, mean squared error, a histogram comparison, and/or otherwise. The result of the similarity assessment may be a similarity score comparing the test frame 120 to each of the indexed images in the lookup table. Accordingly, the similarity lookup component 180 may identify the similarity score indicating a highest similarity, lookup a corresponding sensor displacement and/or rotation (which may be understood to represent a sensor transformation) in the lookup table, and use the sensor displacement and/or rotation as a calibration adjustment. Accordingly, the lookup table may comprise or otherwise identify a collection of sensor data (e.g., images) that represents pre-determined translation and/rotation matrices, and the similarity lookup component 180 may identify the sensor data in the lookup table that is most similar to the test frame 120 and lookup corresponding values that represent a translation and/or rotation matrix.

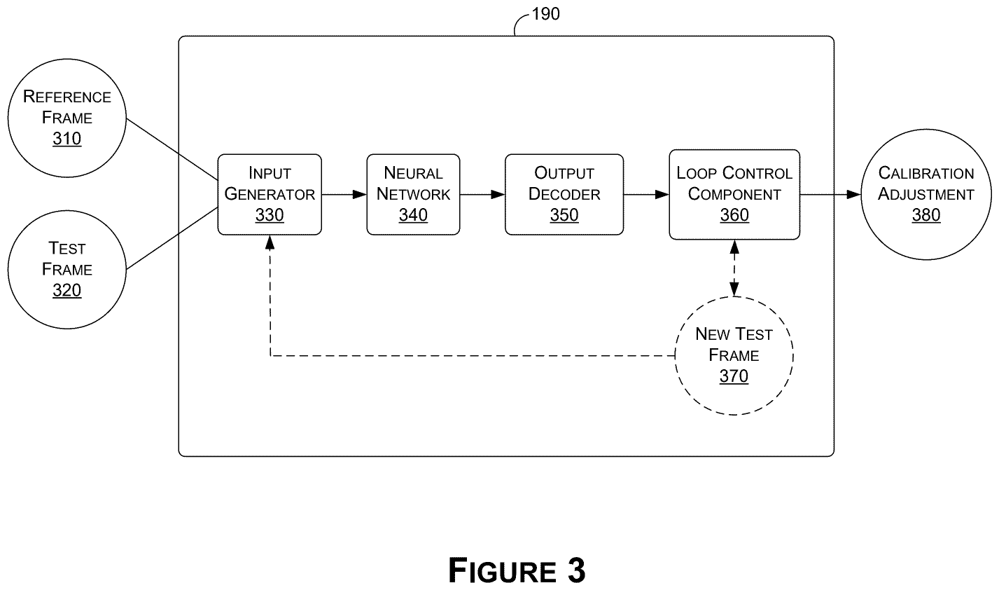

Additionally or alternatively, the neural calibration component 190 may use one or more neural networks to predict the calibration adjustment. FIG. 3 illustrates an example neural calibration component 190, in accordance with some embodiments of the present disclosure. In the embodiment illustrated in FIG. 3, the neural calibration component 190 includes an input generator 330 that formats a reference frame 310 and the test frame 320 into an input that is compatible with the neural network(s) 340 (e.g., via stacking or concatenation) or otherwise applies the reference frame 310 and the test frame 320 to (e.g., separate input channels of) the neural network(s) 340, the neural network(s) 340 processes the input to predict a representation of a calibration adjustment (e.g., encoded components of a corresponding transformation matrix) based on the reference frame 310 and the test frame 320, and an output decoder 350 processes the output of the neural network(s) 340 to decode the calibration adjustment. In some embodiments, the decoded output of a single pass through the neural network(s) 340 may be used as the calibration adjustment 380. However, in some embodiments, a loop control component 360 uses the decoded output of the neural network(s) 340 to determine whether one or more loop completion criteria have been satisfied, iterating the neural calibration component 190 in a loop until one of the criteria is satisfied.

Generally, the neural network(s) 340 may include any type and number of neural networks, such as auto encoders, convolutional, transformer, recurrent, perceptrons, Long/Short Term Memory (LSTM), large language model (LLM), Hopfield, Boltzmann, deep belief, de-convolutional, generative adversarial, liquid state machine, etc.), and/or other types. In an example embodiment, the neural network(s) 340 comprise a Siamese network that accepts a reference frame (e.g., the reference frame 310) and a test frame (e.g., the test frame 320) into different input channels and estimates the transformation between the reference and test frame by predicting an encoded representation of the components of a corresponding rotation and/or translation (e.g., a predicted camera transformation matrix).

In some embodiments, the reference frame 310 corresponds to the reference frame 110 of FIG. 1, and the test frame 320 corresponds to the to the test frame 120 of FIG. 1. In some embodiments, the calibration adjustment component 170 of FIG. 1 uses a calibration adjustment generated by the similarity lookup component 180 to generate a new test frame (e.g., by applying a corresponding transformation to the test frame 120, by adjusting the calibration parameters of the sensor(s) 101 and generating a new test frame using the adjusted calibration parameters), and uses the new test frame as the test frame 320 in FIG. 3. As such, the neural network 340 may compare the reference frame 310 and the test frame 320 to generate an encoded representation of a predicted calibration adjustment, and the output decoder 350 may use any known technique to decode the output and/or otherwise generate or output a representation of the predicted calibration adjustment. In some embodiments, the decoded output may be used as the calibration adjustment 380.

In some embodiments, the loop control component 360 may use the predicted calibration adjustment decoded by the output decoder 350 to determine whether one or more loop completion criteria have been satisfied. For example, the loop control component 360 may determine whether the predicted calibration adjustment (e.g., the magnitude of one or more of the components of a predicted transformation) is lower than some designated threshold and/or whether some designated number of iterations has been satisfied, and if so, may output the predicted calibration adjustment as the calibration adjustment 380. Additionally or alternatively, the loop control component 360 may use the predicted calibration adjustment to generate a new test frame 370 (e.g., by applying a corresponding transformation to the test frame from the preceding iteration, by adjusting the calibration parameters of the sensor(s) 101 and generating a new test frame using the adjusted calibration parameters). In some embodiments, the loop control component 360 may compare the new test frame 370 to the test frame from the preceding iteration to quantify similarity using any known technique, and if the test frames from successive loop iterations are within a threshold measure of similarity, the loop control component 360 may stop the loop and output the calibration adjustment 380 from the preceding iteration. Otherwise, the loop control component 360 may provide the new test frame 370 to the input generator 330 to provide with the reference frame 310 to the neural network 340 for another iteration of the loop. In some embodiments, the loop control component 360 may compare the new test frame 370 to the reference frame 310, quantifying the difference using any known technique, stopping the loop when the difference is below a threshold, and otherwise passing the new test frame 370 for another iteration of the loop. These are just a few examples, and other variations may be implemented within the scope of the present disclosure.

As such and returning to FIG. 1, the calibration adjustment component 170 may generate any suitable representation of a calibration adjustment. In some embodiments, the calibration adjustment component 170 may automatically apply the calibration adjustment to a corresponding one of the sensor(s) 101. Additionally or alternatively, the calibration adjustment component 170 may guide a user to manually adjust the sensor. For example, the calibration adjustment component 170 may visualize the calibration adjustment (e.g., a transformation matrix) on a display visible to a user (e.g., an infotainment screen, a smart device, etc.) in any suitable form (e.g., as a corresponding visual instruction such as an arrow) to guide the user to adjust the sensor position and/or orientation. In some embodiments, the calibration adjustment component 170 may visualize a representation of the reference frame 110, the test frame 120, and/or corresponding masked version(s) representing the static regions on the display, and the calibration adjustment component 170 may update the visualization of the test frame 120 as the user updates the position and/or orientation of the sensor to match the visualized test frame with the visualized reference frame. In some embodiments, the misalignment detector 130 may periodically perform misalignment detection during the manual adjustment, and the calibration adjustment component 170 may compute a corresponding calibration adjustment and present a corresponding visualization on the display to update the guidance during the manual adjustment.

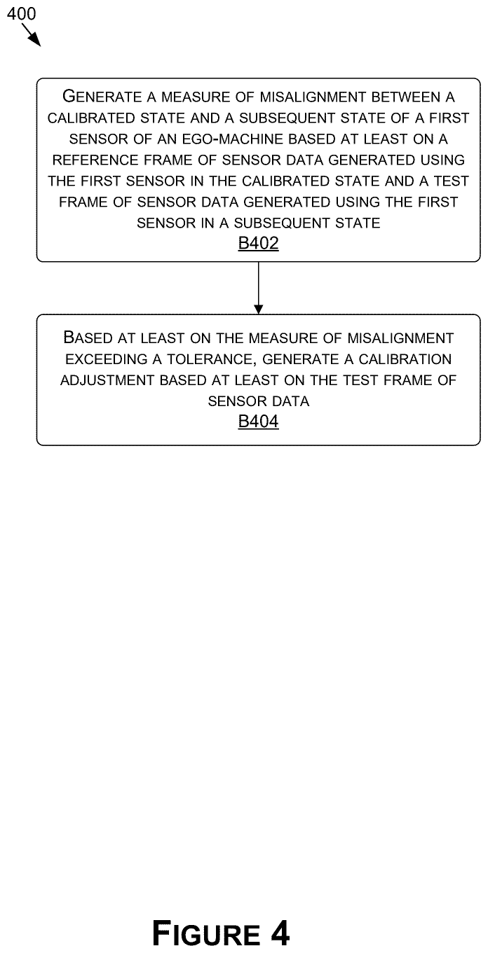

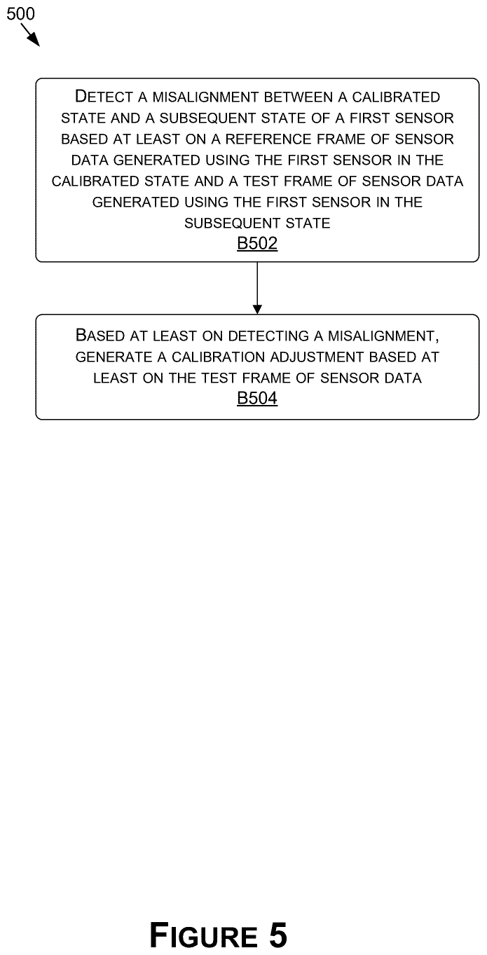

Now referring to FIGS. 4 and 5, each block of methods 400 and 500, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, the methods 400 and 500 are described, by way of example, with respect to the sensor misalignment correction pipeline 100 of FIG. 1. However, these methods may additionally or alternatively be executed by any one system, or any combination of systems, including, but not limited to, those described herein.

FIG. 4 is a flow diagram showing a method 400 for generating a calibration adjustment based at least on a test frame of sensor data, in accordance with some embodiments of the present disclosure. The method 400, at block B402, includes generating a measure of misalignment between a calibrated state and a subsequent state of a first sensor of an ego-machine based at least on a reference frame of sensor data generated using the first sensor in the calibrated state and a test frame of sensor data generated using the first sensor in a subsequent state. For example, with respect to the sensor misalignment correction pipeline 100 of FIG. 1, the misalignment detector 130 may compare the reference frame 110 and the test frame 120 to generate a measure of misalignment between the reference state (e.g., position and orientation) of the sensor(s) 101 in the reference time slice and the subsequent state in the subsequent time slice. More specifically, the masking component 140 may generate a representation of static and/or non-occluded regions in the reference frame 110 and the test frame 120 (e.g., masked frames representing detected static content in the reference frame 110 and the test frame 120), and the difference quantification component 150 may generate a measure of difference or similarity (e.g., SSIM) between the static and/or non-occluded regions and convert the measure of difference or similarity to a corresponding measure of misalignment.

The method 400, at block B404, includes generating a calibration adjustment based at least on the measure of misalignment exceeding a tolerance, where the calibration adjustment is generated based at least on the test frame of sensor data. For example, with respect to the sensor misalignment correction pipeline 100 of FIG. 1, the threshold misalignment identification component 160 may detect whether there is a threshold misalignment between a reference state of the sensor(s) 101 in the reference time slice and a subsequent state in the test time slice using the reference frame 110 and the test frame 120 by comparing the measure of misalignment to a designated calibration tolerance. If the measure of misalignment meets and/or exceeds the tolerance, the threshold misalignment identification component 160 may instruct the calibration adjustment component 170 to generate a calibration adjustment and/or calibration adjustment guidance.

FIG. 5 is a flow diagram showing another method 500 for generating a calibration adjustment based at least on quantifying difference or similarity, in accordance with some embodiments of the present disclosure. The method 500, at block B502, includes generating a calibration adjustment to a calibration of a first sensor based at least on quantifying the difference or similarity between a reference frame of sensor data generated using the first sensor in a calibrated state and a test frame of sensor data generated using the first sensor in a subsequent state. For example, with respect to the sensor misalignment correction pipeline 100 of FIG. 1, the misalignment detector 130 (e.g., the masking component 140) may generate a representation of static and/or non-occluded regions in the reference frame 110 and the test frame 120, and the misalignment detector 130 (e.g., the difference quantification component 150) may generate a measure of difference or similarity (e.g., SSIM) between the static and/or non-occluded regions and convert the measure of difference or similarity to a corresponding measure of misalignment. The misalignment detector 130 (e.g., the threshold misalignment identification component 160) may compare the measure of misalignment to a designated calibration tolerance. If the measure of misalignment meets and/or exceeds the tolerance, the threshold misalignment identification component 160 may instruct the calibration adjustment component 170 to generate a calibration adjustment and/or calibration adjustment guidance.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs), systems for performing light transport simulation, systems for performing collaborative content creation for 3D assets, systems implemented at least partially using cloud computing resources, and/or other types of systems.

### Example Autonomous Vehicle

FIG. 6A is an illustration of an example autonomous vehicle 600, in accordance with some embodiments of the present disclosure. The autonomous vehicle 600 (alternatively referred to herein as the “vehicle 600”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 600 may be capable of functionality in accordance with one or more of Level 3-Level 5 of the autonomous driving levels. The vehicle 600 may be capable of functionality in accordance with one or more of Level 1-Level 5 of the autonomous driving levels. For example, the vehicle 600 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 600 or other machine, such as being fully autonomous, being highly autonomous, being conditionally autonomous, being partially autonomous, providing assistive autonomy, being semi-autonomous, being primarily autonomous, or other designation.

The vehicle 600 may include components such as a chassis, a vehicle body, wheels (e.g., 2, 4, 6, 8, 18, etc.), tires, axles, and other components of a vehicle. The vehicle 600 may include a propulsion system 650, such as an internal combustion engine, hybrid electric power plant, an all-electric engine, and/or another propulsion system type. The propulsion system 650 may be connected to a drive train of the vehicle 600, which may include a transmission, to allow the propulsion of the vehicle 600. The propulsion system 650 may be controlled in response to receiving signals from the throttle/accelerator 652.

A steering system 654, which may include a steering wheel, may be used to steer the vehicle 600 (e.g., along a desired path or route) when the propulsion system 650 is operating (e.g., when the vehicle is in motion). The steering system 654 may receive signals from a steering actuator 656. The steering wheel may be optional for full automation (Level 5) functionality.

The brake sensor system 646 may be used to operate the vehicle brakes in response to receiving signals from the brake actuators 648 and/or brake sensors.

Controller(s) 636, which may include one or more system on chips (SoCs) 604 (FIG. 6C) and/or GPU(s), may provide signals (e.g., representative of commands) to one or more components and/or systems of the vehicle 600. For example, the controller(s) may send signals to operate the vehicle brakes via one or more brake actuators 648, to operate the steering system 654 via one or more steering actuators 656, to operate the propulsion system 650 via one or more throttle/accelerators 652. The controller(s) 636 may include one or more onboard (e.g., integrated) computing devices (e.g., supercomputers) that process sensor signals, and output operation commands (e.g., signals representing commands) to allow autonomous driving and/or to assist a human driver in driving the vehicle 600. The controller(s) 636 may include a first controller 636 for autonomous driving functions, a second controller 636 for functional safety functions, a third controller 636 for artificial intelligence functionality (e.g., computer vision), a fourth controller 636 for infotainment functionality, a fifth controller 636 for redundancy in emergency conditions, and/or other controllers. In some examples, a single controller 636 may handle two or more of the above functionalities, two or more controllers 636 may handle a single functionality, and/or any combination thereof.

The controller(s) 636 may provide the signals for controlling one or more components and/or systems of the vehicle 600 in response to sensor data received from one or more sensors (e.g., sensor inputs). The sensor data may be received from, for example and without limitation, global navigation satellite systems (“GNSS”) sensor(s) 658 (e.g., Global Positioning System sensor(s)), RADAR sensor(s) 660, ultrasonic sensor(s) 662, LiDAR sensor(s) 664, inertial measurement unit (IMU) sensor(s) 666 (e.g., accelerometer(s), gyroscope(s), magnetic compass(es), magnetometer(s), etc.), microphone(s) 696, stereo camera(s) 668, wide-view camera(s) 670 (e.g., fisheye cameras), infrared camera(s) 672, surround camera(s) 674 (e.g., 360 degree cameras), long-range and/or mid-range camera(s) 698, speed sensor(s) 644 (e.g., for measuring the speed of the vehicle 600), vibration sensor(s) 642, steering sensor(s) 640, brake sensor(s) (e.g., as part of the brake sensor system 646), one or more occupant monitoring system (OMS) sensor(s) 601 (e.g., one or more interior cameras), and/or other sensor types.

One or more of the controller(s) 636 may receive inputs (e.g., represented by input data) from an instrument cluster 632 of the vehicle 600 and provide outputs (e.g., represented by output data, display data, etc.) via a human-machine interface (HMI) display 634, an audible annunciator, a loudspeaker, and/or via other components of the vehicle 600. The outputs may include information such as vehicle velocity, speed, time, map data (e.g., the High Definition (“HD”) map 622 of FIG. 6C), location data (e.g., the vehicle's 600 location, such as on a map), direction, location of other vehicles (e.g., an occupancy grid), information about objects and status of objects as perceived by the controller(s) 636, etc. For example, the HMI display 634 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 600 further includes a network interface 624 which may use one or more wireless antenna(s) 626 and/or modem(s) to communicate over one or more networks. For example, the network interface 624 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 626 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 6B is an example of camera locations and fields of view for the example autonomous vehicle 600 of FIG. 6A, in accordance with some embodiments of the present disclosure. The cameras and respective fields of view are one example embodiment and are not intended to be limiting. For example, additional and/or alternative cameras may be included and/or the cameras may be located at different locations on the vehicle 600.

The camera types for the cameras may include, but are not limited to, digital cameras that may be adapted for use with the components and/or systems of the vehicle 600. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 600 (e.g., front-facing cameras) may be used for surround view, to help identify forward facing paths and obstacles, as well aid in, with the help of one or more controllers 636 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 670 that may be used to perceive objects coming into view from the periphery (e.g., pedestrians, crossing traffic or bicycles). Although only one wide-view camera is illustrated in FIG. 6B, there may be any number (including zero) of wide-view cameras 670 on the vehicle 600. In addition, any number of long-range camera(s) 698 (e.g., a long-view stereo camera pair) may be used for depth-based object detection, especially for objects for which a neural network has not yet been trained. The long-range camera(s) 698 may also be used for object detection and classification, as well as basic object tracking.

Any number of stereo cameras 668 may also be included in a front-facing configuration. In at least one embodiment, one or more of stereo camera(s) 668 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 668 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 668 may be used in addition to, or alternatively from, those described herein.

Cameras with a field of view that include portions of the environment to the side of the vehicle 600 (e.g., side-view cameras) may be used for surround view, providing information used to create and update the occupancy grid, as well as to generate side impact collision warnings. For example, surround camera(s) 674 (e.g., four surround cameras 674 as illustrated in FIG. 6B) may be positioned to on the vehicle 600. The surround camera(s) 674 may include wide-view camera(s) 670, fisheye camera(s), 360 degree camera(s), and/or the like. Four example, four fisheye cameras may be positioned on the vehicle's front, rear, and sides. In an alternative arrangement, the vehicle may use three surround camera(s) 674 (e.g., left, right, and rear), and may leverage one or more other camera(s) (e.g., a forward-facing camera) as a fourth surround view camera.

Cameras with a field of view that include portions of the environment to the rear of the vehicle 600 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 698, stereo camera(s) 668), infrared camera(s) 672, etc.), as described herein.

Cameras with a field of view that include portions of the interior environment within the cabin of the vehicle 600 (e.g., one or more OMS sensor(s) 601) may be used as part of an occupant monitoring system (OMS) such as, but not limited to, a driver monitoring system (DMS). For example, OMS sensors (e.g., the OMS sensor(s) 601) may be used (e.g., by the controller(s) 636) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 6C is a block diagram of an example system architecture for the example autonomous vehicle 600 of FIG. 6A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 600 in FIG. 6C are illustrated as being connected via bus 602. The bus 602 may include a Controller Area Network (CAN) data interface (alternatively referred to herein as a “CAN bus”). A CAN may be a network inside the vehicle 600 used to aid in control of various features and functionality of the vehicle 600, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 602 is described herein as being a CAN bus, this is not intended to be limiting. For example, in addition to, or alternatively from, the CAN bus, FlexRay and/or Ethernet may be used. Additionally, although a single line is used to represent the bus 602, this is not intended to be limiting. For example, there may be any number of busses 602, which may include one or more CAN busses, one or more FlexRay busses, one or more Ethernet busses, and/or one or more other types of busses using a different protocol. In some examples, two or more busses 602 may be used to perform different functions, and/or may be used for redundancy. For example, a first bus 602 may be used for collision avoidance functionality and a second bus 602 may be used for actuation control. In any example, each bus 602 may communicate with any of the components of the vehicle 600, and two or more busses 602 may communicate with the same components. In some examples, each SoC 604, each controller 636, and/or each computer within the vehicle may have access to the same input data (e.g., inputs from sensors of the vehicle 600), and may be connected to a common bus, such the CAN bus.

The vehicle 600 may include one or more controller(s) 636, such as those described herein with respect to FIG. 6A. The controller(s) 636 may be used for a variety of functions. The controller(s) 636 may be coupled to any of the various other components and systems of the vehicle 600, and may be used for control of the vehicle 600, artificial intelligence of the vehicle 600, infotainment for the vehicle 600, and/or the like.

The vehicle 600 may include a system(s) on a chip (SoC) 604. The SoC 604 may include CPU(s) 606, GPU(s) 608, processor(s) 610, cache(s) 612, accelerator(s) 614, data store(s) 616, and/or other components and features not illustrated. The SoC(s) 604 may be used to control the vehicle 600 in a variety of platforms and systems. For example, the SoC(s) 604 may be combined in a system (e.g., the system of the vehicle 600) with an HD map 622 which may obtain map refreshes and/or updates via a network interface 624 from one or more servers (e.g., server(s) 678 of FIG. 6D).

The CPU(s) 606 may include a CPU cluster or CPU complex (alternatively referred to herein as a “CCPLEX”). The CPU(s) 606 may include multiple cores and/or L2 caches. For example, in some embodiments, the CPU(s) 606 may include eight cores in a coherent multi-processor configuration. In some embodiments, the CPU(s) 606 may include four dual-core clusters where each cluster has a dedicated L2 cache (e.g., a 2 MB L2 cache). The CPU(s) 606 (e.g., the CCPLEX) may be configured to support simultaneous cluster operation allowing any combination of the clusters of the CPU(s) 606 to be active at any given time.

The CPU(s) 606 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 606 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 608 may include an integrated GPU (alternatively referred to herein as an “iGPU”). The GPU(s) 608 may be programmable and may be efficient for parallel workloads. The GPU(s) 608, in some examples, may use an enhanced tensor instruction set. The GPU(s) 608 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 608 may include at least eight streaming microprocessors. The GPU(s) 608 may use compute application programming interface(s) (API(s)). In addition, the GPU(s) 608 may use one or more parallel computing platforms and/or programming models (e.g., NVIDIA's CUDA).

The GPU(s) 608 may be power-optimized for best performance in automotive and embedded use cases. For example, the GPU(s) 608 may be fabricated on a Fin field-effect transistor (FinFET). However, this is not intended to be limiting and the GPU(s) 608 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 608 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 608 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 608 to access the CPU(s) 606 page tables directly. In such examples, when the GPU(s) 608 memory management unit (MMU) experiences a miss, an address translation request may be transmitted to the CPU(s) 606. In response, the CPU(s) 606 may look in its page tables for the virtual-to-physical mapping for the address and transmits the translation back to the GPU(s) 608. As such, unified memory technology may allow a single unified virtual address space for memory of both the CPU(s) 606 and the GPU(s) 608, thereby simplifying the GPU(s) 608 programming and porting of applications to the GPU(s) 608.

In addition, the GPU(s) 608 may include an access counter that may keep track of the frequency of access of the GPU(s) 608 to memory of other processors. The access counter may help ensure that memory pages are moved to the physical memory of the processor that is accessing the pages most frequently.

The SoC(s) 604 may include any number of cache(s) 612, including those described herein. For example, the cache(s) 612 may include an L3 cache that is available to both the CPU(s) 606 and the GPU(s) 608 (e.g., that is connected both the CPU(s) 606 and the GPU(s) 608). The cache(s) 612 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 604 may include an arithmetic logic unit(s) (ALU(s)) which may be leveraged in performing processing with respect to any of the variety of tasks or operations of the vehicle 600—such as processing DNNs. In addition, the SoC(s) 604 may include a floating point unit(s) (FPU(s))—or other math coprocessor or numeric coprocessor types—for performing mathematical operations within the system. For example, the SoC(s) 604 may include one or more FPUs integrated as execution units within a CPU(s) 606 and/or GPU(s) 608.

The SoC(s) 604 may include one or more accelerators 614 (e.g., hardware accelerators, software accelerators, or a combination thereof). For example, the SoC(s) 604 may include a hardware acceleration cluster that may include optimized hardware accelerators and/or large on-chip memory. The large on-chip memory (e.g., 4 MB of SRAM), may allow the hardware acceleration cluster to accelerate neural networks and other calculations. The hardware acceleration cluster may be used to complement the GPU(s) 608 and to off-load some of the tasks of the GPU(s) 608 (e.g., to free up more cycles of the GPU(s) 608 for performing other tasks). As an example, the accelerator(s) 614 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 614 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 608, and by using an inference accelerator, for example, a designer may target either the DLA(s) or the GPU(s) 608 for any function. For example, the designer may focus processing of CNNs and floating point operations on the DLA(s) and leave other functions to the GPU(s) 608 and/or other accelerator(s) 614.

The accelerator(s) 614 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 606. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 614 (e.g., the hardware acceleration cluster) may include a computer vision network on-chip and SRAM, for providing a high-bandwidth, low latency SRAM for the accelerator(s) 614. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 604 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 614 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 666 output that correlates with the vehicle 600 orientation, distance, 3D location estimates of the object obtained from the neural network and/or other sensors (e.g., LiDAR sensor(s) 664 or RADAR sensor(s) 660), among others.

The SoC(s) 604 may include data store(s) 616 (e.g., memory). The data store(s) 616 may be on-chip memory of the SoC(s) 604, which may store neural networks to be executed on the GPU and/or the DLA. In some examples, the data store(s) 616 may be large enough in capacity to store multiple instances of neural networks for redundancy and safety. The data store(s) 616 may comprise L2 or L3 cache(s) 612. Reference to the data store(s) 616 may include reference to the memory associated with the PVA, DLA, and/or other accelerator(s) 614, as described herein.

The SoC(s) 604 may include one or more processor(s) 610 (e.g., embedded processors). The processor(s) 610 may include a boot and power management processor that may be a dedicated processor and subsystem to handle boot power and management functions and related security enforcement. The boot and power management processor may be a part of the SoC(s) 604 boot sequence and may provide runtime power management services. The boot power and management processor may provide clock and voltage programming, assistance in system low power state transitions, management of SoC(s) 604 thermals and temperature sensors, and/or management of the SoC(s) 604 power states. Each temperature sensor may be implemented as a ring-oscillator whose output frequency is proportional to temperature, and the SoC(s) 604 may use the ring-oscillators to detect temperatures of the CPU(s) 606, GPU(s) 608, and/or accelerator(s) 614. If temperatures are determined to exceed a threshold, the boot and power management processor may enter a temperature fault routine and put the SoC(s) 604 into a lower power state and/or put the vehicle 600 into a chauffeur to safe stop mode (e.g., bring the vehicle 600 to a safe stop).

The processor(s) 610 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 610 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 610 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 610 may further include a real-time camera engine that may include a dedicated processor subsystem for handling real-time camera management.

The processor(s) 610 may further include a high-dynamic range signal processor that may include an image signal processor that is a hardware engine that is part of the camera processing pipeline.

The processor(s) 610 may include a video image compositor that may be a processing block (e.g., implemented on a microprocessor) that implements video post-processing functions needed by a video playback application to produce the final image for the player window. The video image compositor may perform lens distortion correction on wide-view camera(s) 670, surround camera(s) 674, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 608 is not required to continuously render new surfaces. Even when the GPU(s) 608 is powered on and active doing 3D rendering, the video image compositor may be used to offload the GPU(s) 608 to improve performance and responsiveness.

The SoC(s) 604 may further include a mobile industry processor interface (MIPI) camera serial interface for receiving video and input from cameras, a high-speed interface, and/or a video input block that may be used for camera and related pixel input functions. The SoC(s) 604 may further include an input/output controller(s) that may be controlled by software and may be used for receiving I/O signals that are uncommitted to a specific role.

The SoC(s) 604 may further include a broad range of peripheral interfaces to allow communication with peripherals, audio codecs, power management, and/or other devices. The SoC(s) 604 may be used to process data from cameras (e.g., connected over Gigabit Multimedia Serial Link and Ethernet), sensors (e.g., LiDAR sensor(s) 664, RADAR sensor(s) 660, etc. that may be connected over Ethernet), data from bus 602 (e.g., speed of vehicle 600, steering wheel position, etc.), data from GNSS sensor(s) 658 (e.g., connected over Ethernet or CAN bus). The SoC(s) 604 may further include dedicated high-performance mass storage controllers that may include their own DMA engines, and that may be used to free the CPU(s) 606 from routine data management tasks.

The SoC(s) 604 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 604 may be faster, more reliable, and even more energy-efficient and space-efficient than conventional systems. For example, the accelerator(s) 614, when combined with the CPU(s) 606, the GPU(s) 608, and the data store(s) 616, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 620) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 608.

In some examples, a CNN for facial recognition and vehicle owner identification may use data from camera sensors to identify the presence of an authorized driver and/or owner of the vehicle 600. The always on sensor processing engine may be used to unlock the vehicle when the owner approaches the driver door and turn on the lights, and, in security mode, to disable the vehicle when the owner leaves the vehicle. In this way, the SoC(s) 604 provide for security against theft and/or carjacking.

In another example, a CNN for emergency vehicle detection and identification may use data from microphones 696 to detect and identify emergency vehicle sirens. In contrast to conventional systems, that use general classifiers to detect sirens and manually extract features, the SoC(s) 604 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 658. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 662, until the emergency vehicle(s) passes.

The vehicle may include a CPU(s) 618 (e.g., discrete CPU(s), or dCPU(s)), that may be coupled to the SoC(s) 604 via a high-speed interconnect (e.g., PCIe). The CPU(s) 618 may include an X86 processor, for example. The CPU(s) 618 may be used to perform any of a variety of functions, including arbitrating potentially inconsistent results between ADAS sensors and the SoC(s) 604, and/or monitoring the status and health of the controller(s) 636 and/or infotainment SoC 630, for example.

The vehicle 600 may include a GPU(s) 620 (e.g., discrete GPU(s), or dGPU(s)), that may be coupled to the SoC(s) 604 via a high-speed interconnect (e.g., NVIDIA's NVLINK). The GPU(s) 620 may provide additional artificial intelligence functionality, such as by executing redundant and/or different neural networks, and may be used to train and/or update neural networks based on input (e.g., sensor data) from sensors of the vehicle 600.

The vehicle 600 may further include the network interface 624 which may include one or more wireless antennas 626 (e.g., one or more wireless antennas for different communication protocols, such as a cellular antenna, a Bluetooth antenna, etc.). The network interface 624 may be used to allow wireless connectivity over the Internet with the cloud (e.g., with the server(s) 678 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 600 information about vehicles in proximity to the vehicle 600 (e.g., vehicles in front of, on the side of, and/or behind the vehicle 600). This functionality may be part of a cooperative adaptive cruise control functionality of the vehicle 600.

The network interface 624 may include a SoC that provides modulation and demodulation functionality and enables the controller(s) 636 to communicate over wireless networks. The network interface 624 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 600 may further include data store(s) 628 which may include off-chip (e.g., off the SoC(s) 604) storage. The data store(s) 628 may include one or more storage elements including RAM, SRAM, DRAM, VRAM, Flash, hard disks, and/or other components and/or devices that may store at least one bit of data.

The vehicle 600 may further include GNSS sensor(s) 658. The GNSS sensor(s) 658 (e.g., GPS, assisted GPS sensors, differential GPS (DGPS) sensors, etc.), to assist in mapping, perception, occupancy grid generation, and/or path planning functions. Any number of GNSS sensor(s) 658 may be used, including, for example and without limitation, a GPS using a USB connector with an Ethernet to Serial (RS-232) bridge.

The vehicle 600 may further include RADAR sensor(s) 660. The RADAR sensor(s) 660 may be used by the vehicle 600 for long-range vehicle detection, even in darkness and/or severe weather conditions. RADAR functional safety levels may be ASIL B. The RADAR sensor(s) 660 may use the CAN and/or the bus 602 (e.g., to transmit data generated using the RADAR sensor(s) 660) for control and to access object tracking data, with access to Ethernet to access raw data in some examples. A wide variety of RADAR sensor types may be used. For example, and without limitation, the RADAR sensor(s) 660 may be suitable for front, rear, and side RADAR use. In some example, Pulse Doppler RADAR sensor(s) are used.

The RADAR sensor(s) 660 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 660 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 600 surroundings at higher speeds with minimal interference from traffic in adjacent lanes. The other two antennae may expand the field of view, making it possible to quickly detect vehicles entering or leaving the vehicle's 600 lane.

Mid-range RADAR systems may include, as an example, a range of up to 660 m (front) or 80 m (rear), and a field of view of up to 42 degrees (front) or 650 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 600 may further include ultrasonic sensor(s) 662. The ultrasonic sensor(s) 662, which may be positioned at the front, back, and/or the sides of the vehicle 600, may be used for park assist and/or to create and update an occupancy grid. A wide variety of ultrasonic sensor(s) 662 may be used, and different ultrasonic sensor(s) 662 may be used for different ranges of detection (e.g., 2.5 m, 4 m). The ultrasonic sensor(s) 662 may operate at functional safety levels of ASIL B.

The vehicle 600 may include LiDAR sensor(s) 664. The LiDAR sensor(s) 664 may be used for object and pedestrian detection, emergency braking, collision avoidance, and/or other functions. The LiDAR sensor(s) 664 may be functional safety level ASIL B. In some examples, the vehicle 600 may include multiple LiDAR sensors 664 (e.g., two, four, six, etc.) that may use Ethernet (e.g., to provide data to a Gigabit Ethernet switch).

In some examples, the LiDAR sensor(s) 664 may be capable of providing a list of objects and their distances for a 360-degree field of view. Commercially available LiDAR sensor(s) 664 may have an advertised range of approximately 600 m, with an accuracy of 2 cm-3 cm, and with support for a 600 Mbps Ethernet connection, for example. In some examples, one or more non-protruding LiDAR sensors 664 may be used. In such examples, the LiDAR sensor(s) 664 may be implemented as a small device that may be embedded into the front, rear, sides, and/or corners of the vehicle 600. The LiDAR sensor(s) 664, in such examples, may provide up to a 120-degree horizontal and 35-degree vertical field-of-view, with a 200 m range even for low-reflectivity objects. Front-mounted LiDAR sensor(s) 664 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 600. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 664 may be less susceptible to motion blur, vibration, and/or shock.

The vehicle may further include IMU sensor(s) 666. The IMU sensor(s) 666 may be located at a center of the rear axle of the vehicle 600, in some examples. The IMU sensor(s) 666 may include, for example and without limitation, an accelerometer(s), a magnetometer(s), a gyroscope(s), a magnetic compass(es), and/or other sensor types. In some examples, such as in six-axis applications, the IMU sensor(s) 666 may include accelerometers and gyroscopes, while in nine-axis applications, the IMU sensor(s) 666 may include accelerometers, gyroscopes, and magnetometers.

In some embodiments, the IMU sensor(s) 666 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 666 may allow the vehicle 600 to estimate heading without requiring input from a magnetic sensor by directly observing and correlating the changes in velocity from GPS to the IMU sensor(s) 666. In some examples, the IMU sensor(s) 666 and the GNSS sensor(s) 658 may be combined in a single integrated unit.

The vehicle may include microphone(s) 696 placed in and/or around the vehicle 600. The microphone(s) 696 may be used for emergency vehicle detection and identification, among other things.

The vehicle may further include any number of camera types, including stereo camera(s) 668, wide-view camera(s) 670, infrared camera(s) 672, surround camera(s) 674, long-range and/or mid-range camera(s) 698, and/or other camera types. The cameras may be used to capture image data around an entire periphery of the vehicle 600. The types of cameras used depends on the embodiments and requirements for the vehicle 600, and any combination of camera types may be used to provide the necessary coverage around the vehicle 600. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 6A and FIG. 6B.

The vehicle 600 may further include vibration sensor(s) 642. The vibration sensor(s) 642 may measure vibrations of components of the vehicle, such as the axle(s). For example, changes in vibrations may indicate a change in road surfaces. In another example, when two or more vibration sensors 642 are used, the differences between the vibrations may be used to determine friction or slippage of the road surface (e.g., when the difference in vibration is between a power-driven axle and a freely rotating axle).

The vehicle 600 may include an ADAS system 638. The ADAS system 638 may include a SoC, in some examples. The ADAS system 638 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 660, LiDAR sensor(s) 664, and/or a camera(s). The ACC systems may include longitudinal ACC and/or lateral ACC. Longitudinal ACC monitors and controls the distance to the vehicle immediately ahead of the vehicle 600 and automatically adjust the vehicle speed to maintain a safe distance from vehicles ahead. Lateral ACC performs distance keeping, and advises the vehicle 600 to change lanes when necessary. Lateral ACC is related to other ADAS applications such as LCA and CWS.

CACC uses information from other vehicles that may be received via the network interface 624 and/or the wireless antenna(s) 626 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 600), while the I2V communication concept provides information about traffic further ahead. CACC systems may include either or both I2V and V2V information sources. Given the information of the vehicles ahead of the vehicle 600, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 660, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 660, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 600 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 600 if the vehicle 600 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 660, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 600 is backing up. Some RCTW systems include AEB to ensure that the vehicle brakes are applied to avoid a crash. RCTW systems may use one or more rear-facing RADAR sensor(s) 660, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 600, the vehicle 600 itself must, in the case of conflicting results, decide whether to heed the result from a primary computer or a secondary computer (e.g., a first controller 636 or a second controller 636). For example, in some embodiments, the ADAS system 638 may be a backup and/or secondary computer for providing perception information to a backup computer rationality module. The backup computer rationality monitor may run a redundant diverse software on hardware components to detect faults in perception and dynamic driving tasks. Outputs from the ADAS system 638 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 604.

In other examples, ADAS system 638 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 638 may be fed into the primary computer's perception block and/or the primary computer's dynamic driving task block. For example, if the ADAS system 638 indicates a forward crash warning due to an object immediately ahead, the perception block may use this information when identifying objects. In other examples, the secondary computer may have its own neural network which is trained and thus reduces the risk of false positives, as described herein.

The vehicle 600 may further include the infotainment SoC 630 (e.g., an in-vehicle infotainment system (IVI)). Although illustrated and described as a SoC, the infotainment system may not be a SoC, and may include two or more discrete components. The infotainment SoC 630 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 600. For example, the infotainment SoC 630 may radios, disk players, navigation systems, video players, USB and Bluetooth connectivity, carputers, in-car entertainment, Wi-Fi, steering wheel audio controls, hands free voice control, a heads-up display (HUD), an HMI display 634, a telematics device, a control panel (e.g., for controlling and/or interacting with various components, features, and/or systems), and/or other components. The infotainment SoC 630 may further be used to provide information (e.g., visual and/or audible) to a user(s) of the vehicle, such as information from the ADAS system 638, autonomous driving information such as planned vehicle maneuvers, trajectories, surrounding environment information (e.g., intersection information, vehicle information, road information, etc.), and/or other information.

The infotainment SoC 630 may include GPU functionality. The infotainment SoC 630 may communicate over the bus 602 (e.g., CAN bus, Ethernet, etc.) with other devices, systems, and/or components of the vehicle 600. In some examples, the infotainment SoC 630 may be coupled to a supervisory MCU such that the GPU of the infotainment system may perform some self-driving functions in the event that the primary controller(s) 636 (e.g., the primary and/or backup computers of the vehicle 600) fail. In such an example, the infotainment SoC 630 may put the vehicle 600 into a chauffeur to safe stop mode, as described herein.

The vehicle 600 may further include an instrument cluster 632 (e.g., a digital dash, an electronic instrument cluster, a digital instrument panel, etc.). The instrument cluster 632 may include a controller and/or supercomputer (e.g., a discrete controller or supercomputer). The instrument cluster 632 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 630 and the instrument cluster 632. As such, the instrument cluster 632 may be included as part of the infotainment SoC 630, or vice versa.

FIG. 6D is a system diagram for communication between cloud-based server(s) and the example autonomous vehicle 600 of FIG. 6A, in accordance with some embodiments of the present disclosure. The system 676 may include server(s) 678, network(s) 690, and vehicles, including the vehicle 600. The server(s) 678 may include a plurality of GPUs 684(A)-684(H) (collectively referred to herein as GPUs 684), PCIe switches 682(A)-682(D) (collectively referred to herein as PCIe switches 682), and/or CPUs 680(A)-680(B) (collectively referred to herein as CPUs 680). The GPUs 684, the CPUs 680, and the PCIe switches may be interconnected with high-speed interconnects such as, for example and without limitation, NVLink interfaces 688 developed by NVIDIA and/or PCIe connections 686. In some examples, the GPUs 684 are connected via NVLink and/or NVSwitch SoC and the GPUs 684 and the PCIe switches 682 are connected via PCIe interconnects. Although eight GPUs 684, two CPUs 680, and two PCIe switches are illustrated, this is not intended to be limiting. Depending on the embodiment, each of the server(s) 678 may include any number of GPUs 684, CPUs 680, and/or PCIe switches. For example, the server(s) 678 may each include eight, sixteen, thirty-two, and/or more GPUs 684.

The server(s) 678 may receive, over the network(s) 690 and from the vehicles, image data representative of images showing unexpected or changed road conditions, such as recently commenced road-work. The server(s) 678 may transmit, over the network(s) 690 and to the vehicles, neural networks 692, updated neural networks 692, and/or map information 694, including information regarding traffic and road conditions. The updates to the map information 694 may include updates for the HD map 622, such as information regarding construction sites, potholes, detours, flooding, and/or other obstructions. In some examples, the neural networks 692, the updated neural networks 692, and/or the map information 694 may have resulted from new training and/or experiences represented in data received from any number of vehicles in the environment, and/or based on training performed at a datacenter (e.g., using the server(s) 678 and/or other servers).

The server(s) 678 may be used to train machine learning models (e.g., neural networks) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 690, and/or the machine learning models may be used by the server(s) 678 to remotely monitor the vehicles.

In some examples, the server(s) 678 may receive data from the vehicles and apply the data to up-to-date real-time neural networks for real-time intelligent inferencing. The server(s) 678 may include deep-learning supercomputers and/or dedicated AI computers powered by GPU(s) 684, such as a DGX and DGX Station machines developed by NVIDIA. However, in some examples, the server(s) 678 may include deep learning infrastructure that use only CPU-powered datacenters.

The deep-learning infrastructure of the server(s) 678 may be capable of fast, real-time inferencing, and may use that capability to evaluate and verify the health of the processors, software, and/or associated hardware in the vehicle 600. For example, the deep-learning infrastructure may receive periodic updates from the vehicle 600, such as a sequence of images and/or objects that the vehicle 600 has located in that sequence of images (e.g., via computer vision and/or other machine learning object classification techniques). The deep-learning infrastructure may run its own neural network to identify the objects and compare them with the objects identified by the vehicle 600 and, if the results do not match and the infrastructure concludes that the AI in the vehicle 600 is malfunctioning, the server(s) 678 may transmit a signal to the vehicle 600 instructing a fail-safe computer of the vehicle 600 to assume control, notify the passengers, and complete a safe parking maneuver.

For inferencing, the server(s) 678 may include the GPU(s) 684 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, included wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may allow the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 833, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may use distributed file system 838 for large-scale data processing (e.g., “big data”). In at least one embodiment, job scheduler 833 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 833. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

The disclosure of this application also includes the following numbered clauses:

Clause 1. One or more processors comprising processing circuitry to determine a measure of misalignment between a calibrated state and a subsequent state of a sensor based at least on a reference frame of sensor data generated using the sensor in the calibrated state and a test frame of sensor data generated using the sensor in a subsequent state.

Clause 2. The one or more processors of clause 1, wherein, based at least on the measure of misalignment exceeding a tolerance, the processing circuitry is further to generate a calibration adjustment based at least on the test frame of sensor data.

Clause 3. The one or more processors of clause 1 or 2, wherein to determine the measure of misalignment, the processing circuitry is further to determine a measure of difference or similarity between the reference frame and the test frame.

Clause 4. The one or more processors of clause 1 or 2, wherein the processing circuitry is further to determine a measure of difference or similarity between one or more static regions of the reference frame and the test frame.

Clause 5. The one or more processors of clause 1, 2 or 4, wherein the processing circuitry is further to apply high pass filtering to the one or more static regions of the reference frame and test frame.

Clause 6. The one or more processors of clause 1 or 2, wherein the tolerance is associated with a characteristic of a neural network.

Clause 7. The one or more processors of clause 1, 2 or 6, wherein an input of the neural network includes sensor data generated using the sensor.

Clause 8. The one or more processors of clause 1 or 2, wherein the processing circuitry is further to convert a measure of difference or similarity between the reference frame and an indexed frame to the calibration adjustment.

Clause 9. The one or more processors of clause 1 or 2, wherein the processing circuitry is further to generate the calibration adjustment based at least on processing the reference frame of sensor data using a neural network.

Clause 10. The one or more processors of clause 1 or 2, wherein the processing circuitry is further to generate the calibration adjustment based at least on iteratively refining a calibration adjustment predicted using a neural network.

Clause 11. The one or more processors of clause 1 or 2, wherein the processing circuitry is further to generate an initial calibration adjustment based at least on a measure of difference or similarity between the reference frame and an indexed frame, and to generate the calibration adjustment based at least on processing a new frame using a neural network, the new frame being generated using the sensor and based on the initial calibration adjustment.

Clause 12. The one or more processors of clause 1 or 2, wherein the sensor is a sensor of an ego-machine, and the processing circuitry is further to automatically apply the calibration adjustment to a calibration of the sensor of the ego-machine.

Clause 13. The one or more processors of clause 1 or 2, wherein the processing circuitry is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

Clause 14. A system comprising one or more processors to generate a calibration adjustment for a sensor based at least on quantifying a difference or similarity between a reference frame of sensor data generated using the sensor in a calibrated state and a test frame of sensor data generated using the sensor in a subsequent state.

Clause 15. The system of clause 14, wherein the one or more processors are further to convert a measure of the difference or similarity between the reference frame and an indexed frame to the calibration adjustment.

Clause 16. The system of clause 14, wherein the one or more processors are further to generate the calibration adjustment based at least on predicting a calibration adjustment using a neural network, and iteratively refining the calibration adjustment.

Clause 17. The system of clause 14, wherein the one or more processors are further to generate an initial calibration adjustment based at least on a measure of the difference or similarity between the reference frame and an indexed frame, and to generate the calibration adjustment based at least on processing a new frame and using a neural network, the new frame generated using the first sensor and based on the initial calibration adjustment.

Clause 18. The system of clause 14, wherein the one or more processors are further to automatically apply the calibration adjustment to a calibration of the sensor.

Clause 19. The system of clause 14, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

Clause 20. A method comprising detecting a misalignment between a calibrated state and a subsequent state of a sensor based at least on a reference frame of sensor data generated using the sensor in the calibrated state and a test frame of sensor data generated using the first sensor in the subsequent state.

Clause 21. The method of clause 20, further comprising, based at least on detecting the misalignment, generating a calibration adjustment based at least on the test frame of sensor data.

Clause 22. The method of clause 20 or 21, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

What is claimed is:

1. One or more processors comprising processing circuitry to:
determine a measure of misalignment between a calibrated state and a subsequent state of a sensor based at least on a reference frame of sensor data generated using the sensor in the calibrated state and a test frame of sensor data generated using the sensor in a subsequent state; and
based at least on the measure of misalignment exceeding a tolerance, generate a calibration adjustment based at least on the test frame of sensor data.

2. The one or more processors of claim 1, wherein to determine the measure of misalignment, the processing circuitry is further to determine a measure of difference or similarity between the reference frame and the test frame.

3. The one or more processors of claim 1, wherein the processing circuitry is further to determine a measure of difference or similarity between one or more static regions of the reference frame and the test frame.

4. The one or more processors of claim 3, wherein the processing circuitry is further to apply high pass filtering to the one or more static regions of the reference frame and test frame.

5. The one or more processors of claim 1, wherein the tolerance is associated with a characteristic of a neural network.

6. The one or more processors of claim 5, wherein an input of the neural network includes sensor data generated using the sensor.

7. The one or more processors of claim 1, wherein the processing circuitry is further to convert a measure of difference or similarity between the reference frame and an indexed frame to the calibration adjustment.

8. The one or more processors of claim 1, wherein the processing circuitry is further to generate the calibration adjustment based at least on processing the reference frame of sensor data using a neural network.

9. The one or more processors of claim 1, wherein the processing circuitry is further to generate the calibration adjustment based at least on iteratively refining a calibration adjustment predicted using a neural network.

10. The one or more processors of claim 1, wherein the processing circuitry is further to generate an initial calibration adjustment based at least on a measure of difference or similarity between the reference frame and an indexed frame, and to generate the calibration adjustment based at least on processing a new frame using a neural network, the new frame being generated using the sensor and based on the initial calibration adjustment.

11. The one or more processors of claim 1, wherein the sensor is a sensor of an ego-machine, and the processing circuitry is further to automatically apply the calibration adjustment to a calibration of the sensor of the ego-machine.

12. The one or more processors of claim 1, wherein the processing circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

13. A system comprising one or more processors to generate a calibration adjustment for a sensor based at least on quantifying a difference or similarity between a reference frame of sensor data generated using the sensor in a calibrated state and a test frame of sensor data generated using the sensor in a subsequent state.

14. The system of claim 13, wherein the one or more processors are further to convert a measure of the difference or similarity between the reference frame and an indexed frame to the calibration adjustment.

15. The system of claim 13, wherein the one or more processors are further to generate the calibration adjustment based at least on predicting a calibration adjustment using a neural network, and iteratively refining the calibration adjustment.

16. The system of claim 13, wherein the one or more processors are further to generate an initial calibration adjustment based at least on a measure of the difference or similarity between the reference frame and an indexed frame, and to generate the calibration adjustment based at least on processing a new frame and using a neural network, the new frame generated using the first sensor and based on the initial calibration adjustment.

17. The system of claim 13, wherein the one or more processors are further to automatically apply the calibration adjustment to a calibration of the sensor.

18. The system of claim 13, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

19. A method comprising:
detecting a misalignment between a calibrated state and a subsequent state of a sensor based at least on a reference frame of sensor data generated using the sensor in the calibrated state and a test frame of sensor data generated using the first sensor in the subsequent state; and
based at least on detecting the misalignment, generating a calibration adjustment based at least on the test frame of sensor data.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
